(19) United States
(12) Patent Application Publication
(10) Pub. No.: US 2015/0152670 A1
(43) Pub. Date: Jun. 4, 2015

(54) HOOK LOCK FOR SECURING MERCHANDISE ON PRODUCT DISPLAY HOOKS

(71) Applicant: James J. Kopco, Mentor-on-the-Lake, OH (US)

(72) Inventor: James J. Kopco, Mentor-on-the-Lake, OH (US)

(73) Assignee: Fasteners For Retail, Inc., Twinsburg, OH (US)

(21) Appl. No.: 14/093,898

(22) Filed: Dec. 2, 2013

(51) Int. Cl. E05B 73/00

(52) U.S. Cl. CPC E05B 73/0017

(57) ABSTRACT

A hook lock device for use in connection with an associated loop type display hook to prevent the removal of associated merchandise suspended from the loop hook includes a housing that defines a cavity configured to accommodate a distal end of the display hook. A plunger lock mechanism is attached to the housing. A plug or locking pin is operably connected to the plunger lock mechanism such that the plunger lock mechanism is configured to selectively move the plug between an unlocked condition, wherein the plug is retracted out of the cavity, and a locked condition, wherein the plug is extended at least partially within the cavity such that the housing cannot be removed from the distal end of the associated display hook.

### BACKGROUND

The present disclosure relates to a hook lock device for securing merchandise that is hung and displayed on product display hooks. It finds particular application in conjunction with securing merchandise on cantilevered loop type display hooks, and will be described with particular reference thereto. However, it is to be appreciated that the present exemplary embodiment is also amenable to other like applications.

Many stores sell a variety of retail items that have various geometric shapes. It is desirable to display such merchandise in packages such that the merchandise is readily accessible to potential purchasers. For example, merchants utilize product display hooks which protrude forward in a cantilevered arrangement from shelf walls or pegboards that support merchandise thereon. Display hooks can be formed of wire or metal rods and merchandise is hung therefrom. Alternatively, such hook arrangements can be made from suitable thermoplastics. The merchandise generally includes packaging having an aperture suitable for being slidably mounted on a single rod or a double rod of a suitably configured display hook.

A loop type display hook generally includes a pair of longitudinal rods that attach to the shelf wall at a proximal end and are connected to one another in a rounded configuration at an opposite, distal, end thereof. Merchandise is slid past the proximal end of the display hook and is supported on the double rods of the loop type display hook.

For high value merchandise, locks are sometimes used on the distal ends of single rod display hooks. Such locks have been employed to reduce the risk of shoplifting. U.S. Pat. No. 6,622,979 to Valiulis discloses a locking hook device configured to be mounted to the distal end of a single rod display hook. Additionally, U.S. Pat. No. 8,281,624 to Rizzi discloses an anti-shoplifting device for a loop type display hook with double rods. Other anti-shoplifting devices are known, however, these devices include various contraptions that incorporate built-in locking arrangements that are bulky, costly and/or unattractive. These devices may also include multiple moving parts that can become separated and easily lost when not in use.

Therefore, there remains a need to provide a lock that is capable of securing merchandise on a loop type display hook having double rods, which lock does not include multiple attachments or additional working parts, that is easy to use, sturdy, not bulky or unattractive and can be easily attached to and detached from the distal end of a loop type display hook. It would also be advantageous if the lock could accommodate a display area for holding information concerning the product mounted on the display hook.

### BRIEF DESCRIPTION

In one embodiment, the present disclosure pertains to a hook lock device for use in connection with an associated loop type display hook to prevent the removal of associated merchandise suspended from the display hook. The hook lock device includes a housing that defines a cavity configured to accommodate a distal end of the display hook. A tumbler lock mechanism or a plunger lock mechanism is mounted to the housing and is in communication with the cavity. A plug or locking pin is operably connected to the tumbler lock mechanism such that the tumbler lock mechanism is configured to selectively position the plug in either an unlocked condition, wherein the plug is retracted out of the cavity, and a locked condition, wherein the plug is extended at least partially within the cavity such that the housing cannot be removed from the distal end of the associated display hook.

The plug is configured to translate along a central axis of the housing. The distal end of the associated hook lock is received within the opening and extends past the central axis within the cavity to be placed in the locked condition.

According to another embodiment, disclosed is a hook lock device for use in connection with an associated loop type display hook is disclosed to retard the removal of associated merchandise from the associated display hook. The hook lock device comprises a housing defining a cavity having an opening shaped to receive a distal end of the associated display hook. The opening includes a width dimension and a height dimension such that the width dimension is greater than the height dimension. A plunger lock mechanism is attached to the housing. A locking pin is positioned within the housing and is operably connected to the plunger lock mechanism such that the plunger lock mechanism is configured to selectively move the locking pin between an unlocked condition, wherein the locking pin is retracted out of the cavity, and a locked condition, wherein the locking pin is extended at least partially within the cavity.

In accordance with yet another embodiment of the present disclosure, a hook lock device is provided for use in connection with an associated loop type display hook to retard the removal of associated merchandise suspended from the associated display hook. The hook lock device comprises a housing defining a first cavity for accommodating a distal end of the associated display hook, and a second cavity communicating with the first cavity. A tumbler lock mechanism is mounted in the second cavity. A plug is operably connected to the tumbler lock mechanism such that the tumbler lock mechanism is configured to selectively position the plug in one of an unlocked condition, wherein the plug is retracted out of the first cavity, and a locked condition, wherein the plug is extended at least partially within the first cavity such that the housing cannot be removed from the distal end of the associated display hook.

### BRIEF DESCRIPTION OF THE DRAWINGS

The present disclosure may take form in certain parts and arrangements of parts, an embodiment of which will be described in detail in this specification and illustrated in the accompanying drawings which form a part hereof and wherein:

FIG. 1 is an exploded perspective view of a loop-type display hook including a base along with a hook lock device according to one embodiment of the present disclosure;

FIG. 2 is an enlarged bottom view of the hook lock device of FIG. 1 as it is attached to the display hook;

FIG. 3 is an enlarged cross sectional view of the hook lock device as it is mounted to the display hook of FIG. 2 in an unlocked condition;

FIG. 4 is an enlarged cross sectional view of the hook lock device as it is mounted to the display hook of FIG. 2 in a locked condition

FIG. 5 is a perspective view of one embodiment of the hook lock device attached to the display hook, which is mounted to and extends from a merchandise support wall; and

FIG. 6 is a perspective view of the hook lock device attached to the display hook extending from the merchandise support wall of FIG. 5, wherein merchandise is mounted on the display hook and a key is employed for toggling the lock of the device between the locked and unlocked condition.

### DETAILED DESCRIPTION

It is to be understood that the detailed figures are for purposes of illustrating an exemplary embodiment of the present disclosure only and are not intended to be limiting. Additionally, it will be appreciated that the drawings are not to scale and that portions of certain elements may be exaggerated for the purpose of clarity and ease of illustration.

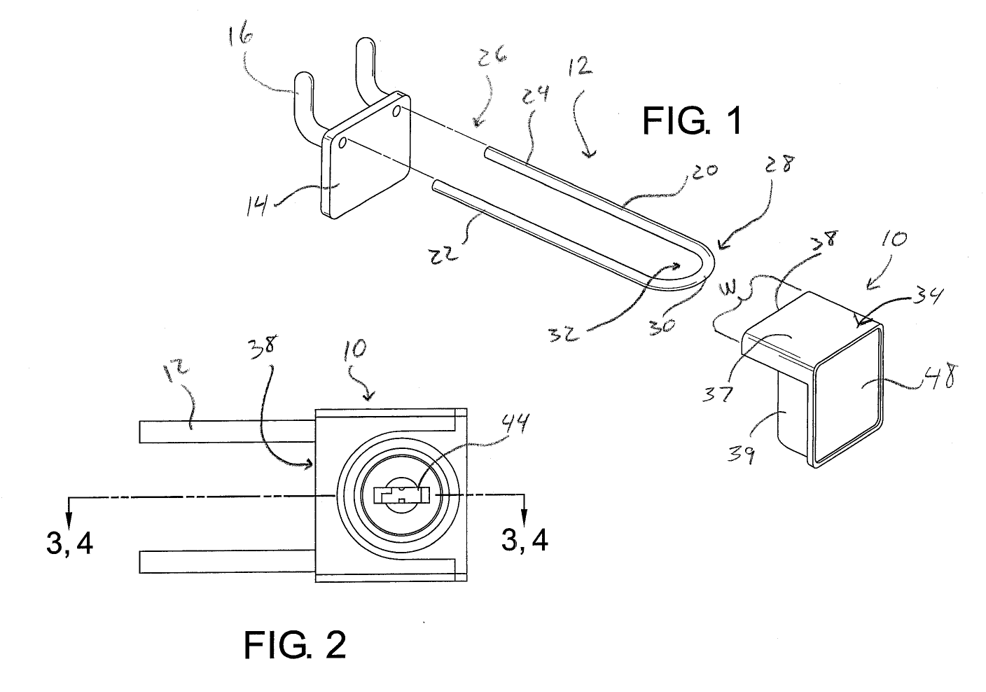

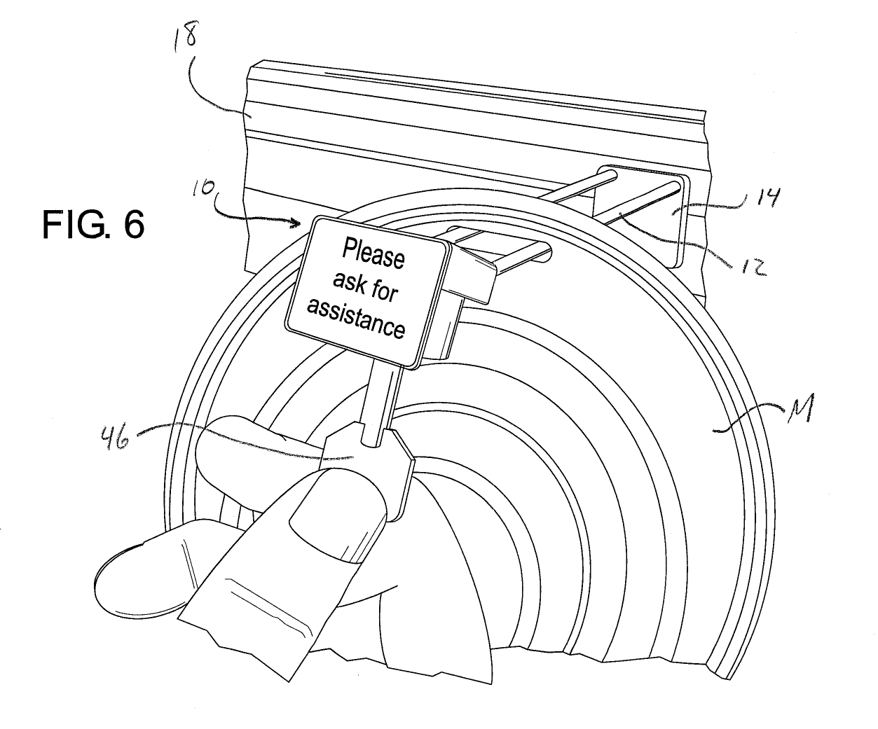

In accordance with the present disclosure, FIG. 1 illustrates a hook lock device 10 for use in connection with a display hook that is configured to support merchandise thereon. The hook lock device 10 is configured to be attached to a loop-type display hook 12 to prevent or retard the unwanted removal of merchandise therefrom. As best shown in FIGS. 5 and 6, the display hook 12 is attached to a base 14 that is configured to be supported on a merchandise support wall 18 such that the display hook 12 protrudes forwardly from the wall in a cantilevered manner. At least one item of merchandise M can be supported on the display hook 12. In the embodiment of FIG. 1, the base 14 includes a pair of spaced upward facing pins, fingers or prongs 16 that are adapted to be inserted in one or more suitable openings in the support wall. For example, in one embodiment, the bins can be inserted into spaced apertures along a conventional pegboard type merchandise wall (not shown). However, this disclosure is not limited as to the type of base employed as long as the base 14 can be securely attached to the merchandise support wall 18. Thus, FIG. 6 illustrates a slot wall type merchandise support wall in which both prongs 16 extend into a common slot.

In one embodiment, the display hook 12 includes an elongated rod 20 that is bent into a U-shape to form or define a first leg 22 and a second leg 24 which are oriented so that they extend generally parallel to each other. The legs 22, 24 are aligned such that a proximal end 26 of the display hook 12 the legs are configured to attach to the base 14 while an opposite distal end 28 of the display hook has a generally rounded front end 30 that can be termed U shaped. The distal end 28 of the display hook defines a loop space 32 between the adjacent legs 20 and 22. It should be recognized that the distal end 28 could have various shapes or configurations that define a loop space 32 and is not limited to having a rounded end. Additionally, the loop hook 12 is not limited to being formed from an elongated rod. It can be formed in various shapes and from various materials and can have different configurations along its length.

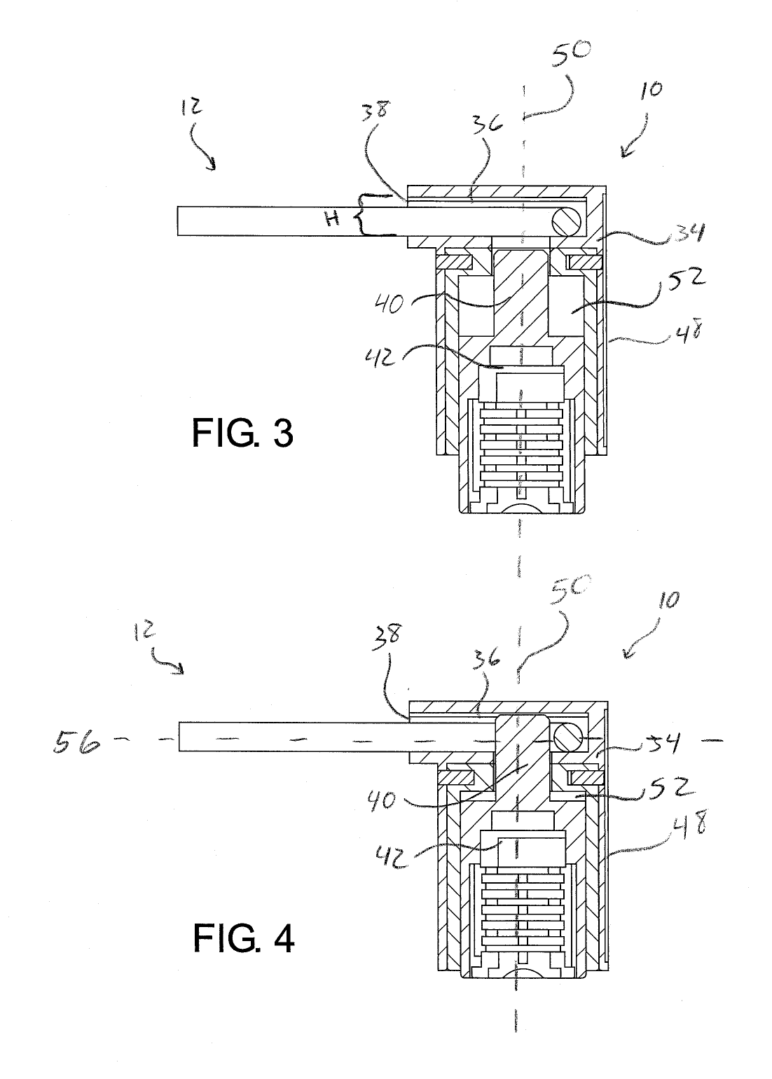

With reference now to FIG. 3, the hook lock device 10 includes a housing 34 that defines a cavity 36 that is shaped to receive the distal end 28 of the display hook 12. The cavity 36 includes an opening 38 shaped to include a width dimension W and a height dimension H (see FIGS. 1 and 3) such that the width dimension W is greater than the height dimension H. This particular feature allows the distal end 28 of the loop hook 12 to be snuggly received within the cavity 36 such that the loop space 32 is particularly positioned within the cavity 36. Such a configuration of the cavity 36 allows a locking pin 40 of a tumbler lock or a plunger lock mechanism 42 to be selectively positioned therein.

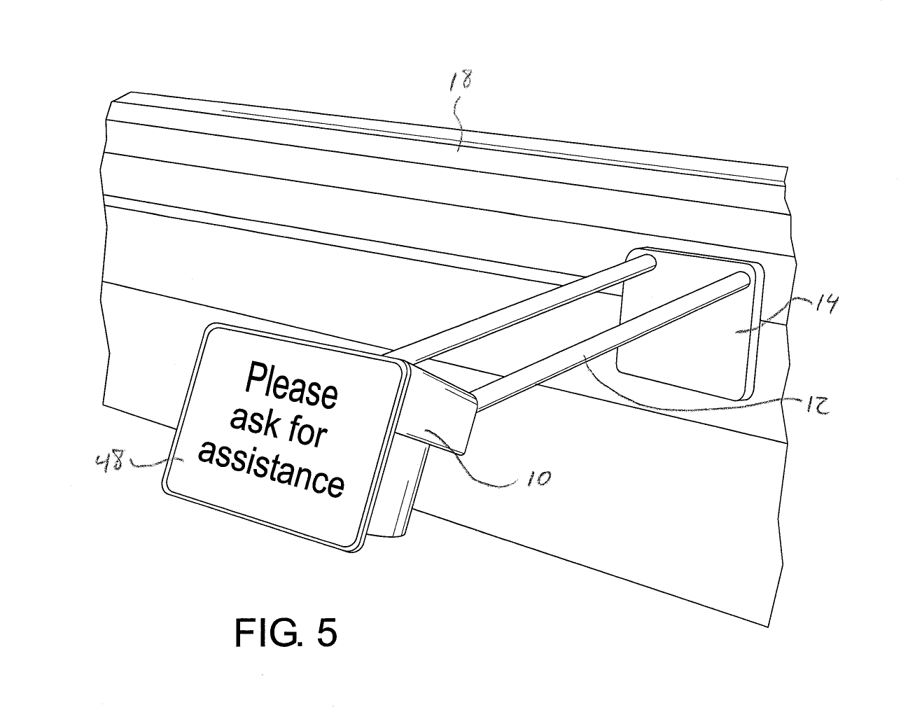

The plunger lock mechanism 42 is held by the housing 34 and the locking pin 40 or plug is operably connected to the plunger lock mechanism such that the locking pin 40 can be selectively moved between an unlocked condition (FIG. 3) wherein the locking pin is retracted out of the cavity 36 and a locked condition (FIG. 4) wherein the locking pin 40 is extended at least partially into the cavity 36. The cavity 36 can be generally horizontally oriented while the plunger lock mechanism 42 is generally vertically oriented relative to the cavity 36 within the housing 34. The locking pin 40 can have a generally tubular configuration if so desired. However, the locking pin could also have a square, rectangular, hexagonal or other configuration if so desired.

As the hook lock device 10 is placed in the locked condition on the hook lock 12, the locking pin 40 protrudes into the cavity 36 and extends within the loop space 32 of the loop hook 12. The rounded end 30 of the loop hook 12 is thus retained within the cavity 36 at a location past a vertically oriented axis 50 of the plunger lock mechanism 42, which axis can also be termed a central axis of the lock mechanism or even of the housing 34.

As shown in FIG. 2, the plunger lock mechanism 42 includes a slot 44 located along a bottom portion of the housing 34 that is opposite from the cavity 36. The slot 44 is configured to receive a key 46 (see FIG. 6) for selectively activating the plunger lock mechanism 42 to move the locking pin 40 between its locked and unlocked conditions. In one embodiment, the slot 44 can be generally linear and can be configured to receive a planar type key. In another embodiment, the slot 44 can be generally circular as in a radial lock type mechanism or a tubular lock mechanism. As such, the key 44 can be a tubular key.

The housing 34 can include a front face 48 which can be planar in configuration. In one embodiment, the front face is adapted to hold a sign or other information. Usually, this information is associated with the merchandise that is to be supported on the loop hook 12. As is evident from FIGS. 1 and 2, the housing 34 can, in one embodiment, have a generally rectangular top face 37 and a generally circular rear face 39. The housing 34 can be made of a suitable thermoplastic material if so desired, or of a known metal. The lock mechanism can be made of a suitable metal.

In one embodiment, as illustrated by FIGS. 2 and 3, the plunger lock mechanism 42 protrudes outwardly from the bottom of a generally vertically oriented socket or second cavity 52 of the housing 34 when the device is in the unlocked condition. When in the locked condition, however, the plunger lock mechanism 42 is substantially retracted into the socket 52 of the housing. The socket 52 can extend along the generally vertically oriented axis 50. The socket 52 is in communication with the cavity 36 such that the locking pin can move along the axis 50 within the socket 52 and into the cavity 36. While the socket 52 is generally vertically oriented, the cavity 36 is generally horizontally oriented and extends along a generally horizontally oriented plane 56 as shown in FIG. 3.

In use, the plunger lock mechanism can be reciprocated from an unlocked condition, illustrated in FIG. 3, to a locked condition, illustrated in FIG. 4. When in the locked condition, merchandise M (see FIG. 6) is retarded from being removed from the display hook 12 due to the presence of the hook lock device 10. When the merchandise M is requested by a customer, a store worker can employ the key 36 to unlock the locking device 10. Once so unlocked, the locking device then can be removed from the front of the display hook 12 thereby allowing the customer to withdraw one or more items of merchandise M from the display hook 12. Thereafter, store personnel can then reinstall the locking device 10 on the display hook 12.

In the embodiment illustrated in FIGS. 5 and 6, the front end of the display hook 12 can have an upwardly turned distal end (not visible). This explains the canted orientation of the hook lock device 10 in FIGS. 5 and 6.

The exemplary embodiments of the disclosure have been described herein. Obviously, modifications and alterations will occur to others upon reading and understanding the preceding detailed description. It is intended that the instant disclosure be construed as including all such modifications and alterations insofar as they come within the scope of the appended claims or the equivalents thereof.

1. A hook lock device for use in connection with an associated loop-type display hook to retard the removal of associated merchandise from the associated display hook, the hook lock device comprising:
a housing defining a cavity having an opening shaped to receive a distal end of the associated display hook wherein the opening includes a width dimension and a height dimension such that the width dimension is greater than the height dimension;
a plunger lock mechanism attached to the housing; and
a locking pin positioned within the housing and operably connected to the plunger lock mechanism such that the plunger lock mechanism is configured to selectively move the locking pin between an unlocked condition, wherein the locking pin is retracted out of the cavity, and a locked condition, wherein the locking pin is extended at least partially within the cavity.

2. The device of claim 1 wherein the associated display hook includes a first leg and a second leg wherein the first leg is attached to the second leg at a distal end of the associated display hook and such distal end is generally U-shaped.

3. The device of claim 2 wherein the locking pin in the locked condition extends between the first and second legs of the associated display hook adjacent the generally U-shaped distal end thereof.

4. The device of claim 1, wherein the cavity is generally horizontally oriented.

5. The device of claim 4, wherein the plunger lock mechanism is mounted in a socket of the housing, which socket is generally vertically oriented relative to the cavity.

6. The device of claim 1, further comprising a key for selectively activating the plunger lock mechanism.

7. The device of claim 6, wherein the key is tubular.

8. The device of claim 1, wherein the housing includes a planar front face.

9. The device of claim 8, wherein the planar front face is adapted to hold a sign.

10. The device of claim 1, wherein the locking pin is configured to translate along a central axis of the housing, wherein a distal end of the associated display hook is received within the cavity and extends past the central axis of the housing to be placed in the locked condition.

11. A hook lock device for use in connection with an associated loop-type display hook to retard the removal of associated merchandise suspended from the associated display hook, the hook lock device comprising:
a housing defining a first cavity for accommodating a distal end of the associated display hook;
a second cavity communicating with the first cavity;
a tumbler lock mechanism mounted in the second cavity; and
a plug operably connected to the tumbler lock mechanism such that the tumbler lock mechanism is configured to selectively position the plug in one of an unlocked condition, wherein the plug is retracted out of the first cavity, and a locked condition, wherein the plug is extended at least partially within the first cavity such that the housing cannot be removed from the distal end of the associated display hook.

12. The device of claim 11, wherein the first cavity is generally horizontally oriented.

13. The device of claim 12, wherein the second cavity is generally vertically oriented.

14. The device of claim 11, further comprising a key for selectively activating the plunger lock mechanism.

15. The device of claim 14, wherein the key is tubular.

16. The device of claim 11, wherein the plug comprises a tubular pin.

17. The device of claim 11, wherein the housing comprises a planar front face.

18. The device of claim 17, wherein the planar front face is adapted to hold a sign.

19. The device of claim 11, wherein the plug is configured to translate along a central axis of the housing, wherein a distal end of the display hook is received within the opening and extends past the central axis of the housing to be placed in the locked condition.

20. The device of claim 19, wherein the plug is configured to be received within a loop space of the display hook to retain the display hook within the cavity.
